(19) United States
(12) Patent Application Publication
(10) Pub. No.: US 2016/0137544 A1
(43) Pub. Date: May 19, 2016

(54) WATER JET LASER CUTTING DEVICE AND CUTTING METHOD

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventor: Yangkun JING, Beijing (CN)

(21) Appl. No.: 14/801,151

(22) Filed: Jul. 16, 2015

(30) Foreign Application Priority Data
Nov. 19, 2014 (CN) 201410664721.2

(51) Int. Cl. C03B 33/08; B23K 26/402; C03B 33/10; B23K 26/146; B23K 26/14; B23K 26/36; B23K 26/142

(52) U.S. Cl. CPC C03B 33/082; B23K 26/36; B23K 26/402; B23K 26/142; B23K 26/146; B23K 26/1476; C03B 33/105

(57) ABSTRACT

There are provided a water jet laser cutting device and cutting method. The water jet laser cutting device includes an impulsive fluid jet unit and at least one laser beam emitting unit. Each laser beam emitting unit is configured to emit laser toward a cutting line, so as to turn a workpiece at the cutting line into a molten state. The impulsive fluid jet unit is configured to jet an impulsive fluid toward the cutting line in a molten state, so as to cut apart the cutting line in a molten state with an impulsive force of the impulsive fluid, and remove molten scraps at the cutting line.

### TECHNICAL FIELD

Embodiments of the present invention relate to a water jet laser cutting device and a cutting method.

### BACKGROUND

The laser cutting is such a cutting technology that for achieving the purpose of cutting, the energy released when a surface of a workpiece is irradiated by laser beams is used to melt or gasify the workpiece. The laser cutting has been widely applied owing to its merits of good cutting quality, fast cutting speed, and so on. Under normal circumstances, when the laser cutting is applied to workpiece cutting, after a workpiece is rendered molten or gasified by irradiating its surface with laser beams, it is also necessary that molten scraps at the cutting location be taken away with the assistance of flow of water or gas, so as to form a kerf at the cutting location. Only in this way, can the object of cutting be achieved.

In prior art, the commonly used auxiliary laser cutting is water-assisted laser cutting, and its method is that, a workpiece is placed into water, so that a cut surface of the workpiece keeps a certain distance from the water surface, and when laser beams irradiate the cut surface of the workpiece via water to render it gasified, molten scraps at the cutting location will be taken away by the heat flow and air bubbles that are brought about by interaction of the laser beams and the workpiece in water, thereby achieving the object of cutting. In addition, in view of the fact that water has a good cooling effect, when the workpiece is irradiated by laser, heating of the workpiece at the non-cutting location can be cooled favorably by water, and in turn, deformation of the workpiece is decreased.

Although water-assisted laser cutting has many merits, it still suffers from the following problems upon cutting of high-precision workpieces, and the first one is that, the cut thickness of the workpiece is very hard to control, easily leading to overcut. Exemplarily, a liquid crystal display panel includes an upper glass substrate and a lower glass substrate that are cell-assembled, and a circuit system is generally arranged on the lower glass substrate. On this account, the cut thickness needs to be precisely controlled when the liquid crystal display panel is cut, so as to avoid the lower glass substrate from being damaged by laser heat while the upper glass substrate is cut. However, as for the water-assisted laser cutting in prior art, owing to the fact that the thermally penetrated thickness of laser cannot be precisely controlled, the circuit system of the lower glass substrate is very easily damaged by laser heat passing through the upper glass substrate, resulting in overcut phenomenon. The second one is that, when a workpiece in water is irradiated by laser, plasma will be generated after water interacts with the laser; and when a precise workpiece is placed in the water that contains plasma, plasma in water will cause harm to the precise workpiece. Exemplarily, when the upper glass substrate of the liquid crystal panel is cut, plasma that will be generated after water interacts with laser may be attached to the lower glass substrate of the liquid crystal panel, thereby making an impact on conductive properties of the lower glass substrate.

### SUMMARY

At least one embodiments of the invention provides a water jet laser cutting device, comprising an impulsive fluid jet unit and at least one laser beam emitting unit, wherein, each laser beam emitting unit is configured to emit a laser beam toward a cutting line, so as to turn a workpiece at the cutting line into a molten state; and the impulsive fluid jet unit is configured to jet an impulsive fluid toward the cutting line in the molten state, so as to cut apart the cutting line in the molten state with an impulsive force of the impulsive fluid, and remove molten scraps at the cutting line.

At least one embodiment of the invention provides a water jet laser cutting method, comprising: irradiating a cutting line by a laser beam, so as to turn a workpiece at the cutting line into a molten state; and impacting the cutting line in the molten state by an impulsive fluid, so as to cut apart the cutting line in the molten state with an impulsive force of the impulsive fluid, and remove molten scraps at the cutting line.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a block diagram illustrating a water jet laser cutting device provided by an embodiment of the invention;

FIG. 2 is a block diagram illustrating a water jet laser cutting device provided by another embodiment of the invention;

FIG. 3 is a structurally schematic view illustrating a water jet laser cutting device provided by an embodiment of the invention;

FIG. 4 is a structurally schematic view illustrating a laser beam emitting unit provided by an embodiment of the invention;

FIG. 5 is a structurally schematic view illustrating an impulsive fluid jet unit provided by an embodiment of the invention; and

FIG. 6 is a flowchart illustrating a water jet laser cutting method provided by an embodiment of the invention.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

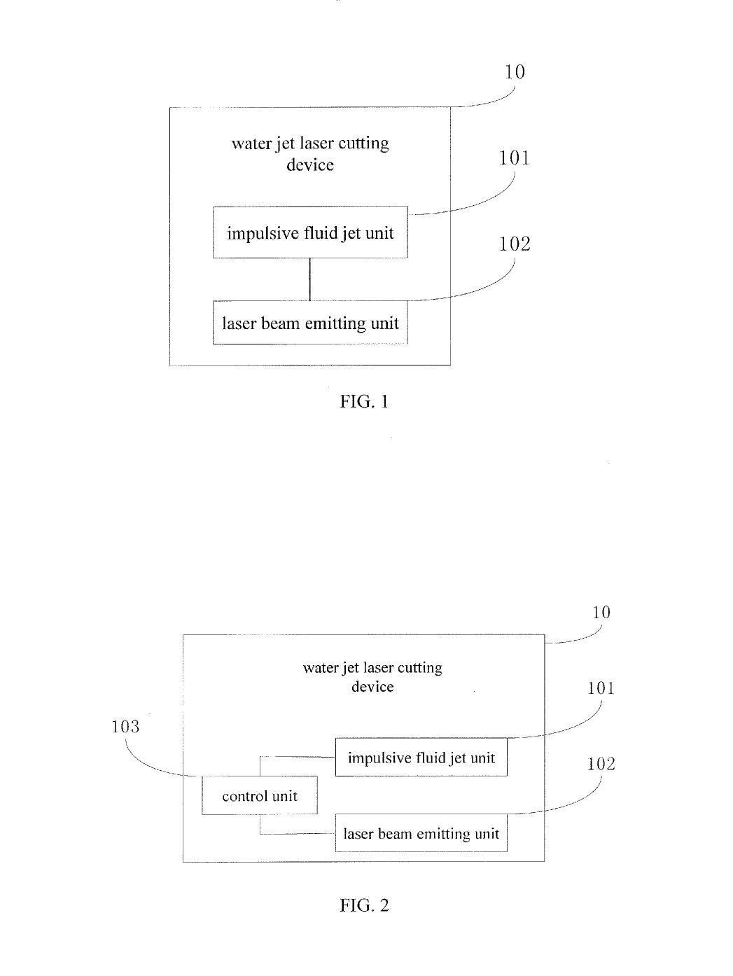

According to an embodiment of the invention, there is provided a water jet laser cutting device 10. As illustrated in FIG. 1, the water jet laser cutting device 10 includes an impulsive fluid jet unit 101 and at least one laser beam emitting unit 102, and each laser beam emitting unit 102 is configured to emit a laser beam toward a cutting line, so as to turn a workpiece at the location of the cutting line into a molten state. The impulsive fluid jet unit 101 is configured to jet impulsive fluid toward the cutting line in a molten state, so as to cut apart the cutting line in a molten state by using an impulsive force of the impulsive fluid, and remove molten scraps at the cutting line. The impulsive fluid is mixture of water and steam.

The molten scraps refer to the workpiece at the cutting line that has been turned into a molten state.

The impulsive fluid is, such as, a mixture of water and steam. The mixing ratio of water and steam can be arbitrarily adjusted according to requirements, and embodiments of the invention do not set a limit to this.

The at least one laser beam emitting unit 102 may include one laser beam emitting unit, and may also include a plurality of laser beam emitting units, and embodiments of the invention do not set a limit to the set number of the laser beam emitting unit. In actual applications, number of the laser beam emitting unit may be set by considering width and thickness of a cutting line of a workpiece, substance of the workpiece, cost of the laser beam emitting unit or other factors comprehensively.

The molten state is a state of matter lying between a solid state and a liquid state. After a solid workpiece is irradiated by the laser beam, it absorbs heat of the laser beam to turn into a molten state, and if the irradiation intensity of the laser beam is increased, it will turn into a liquid state by absorbing more heat. When the workpiece is in a molten state, shape of the workpiece has not been greatly changed yet, but the internal structure has already been destroyed, and the workpiece will become soft.

Laser beam is transmitted by the laser beam emitting unit 102 to the cutting line, so as to turn the workpiece at the cutting line into a molten state. At this time, the laser heat absorbed by the workpiece at the cutting line is less, the workpiece at the cutting line becomes soft, but shape has not been greatly changed yet. In this way, the workpiece at any position other than the cutting line can be protected, to avoid it from being damaged by the laser heat. After that, impulsive fluid is jetted toward the workpiece at the cutting line that has become a molten state with the use of the impulsive fluid jet unit 101. As such, under the impact of the impulsive fluid with a certain pressure, molten scraps at the cutting line will be removed, and the workpiece will be cut open along the cutting line.

Exemplarily, in the event that a glass substrate of a liquid crystal display panel is cut, because the liquid crystal display panel includes an upper glass substrate and a lower glass substrate that are cell-assembled, and a circuit system is generally arranged on the lower glass substrate, the cut thickness has to be precisely controlled for the sake of avoiding the lower glass substrate from being damaged by laser heat when the upper glass substrate is cut. When a water jet laser cutting device provided by an embodiment of the invention is used to cut the upper glass substrate of the liquid crystal display panel, firstly, a laser beam is transmitted by the laser beam emitting unit 102 to a cutting line of the upper glass substrate, so as to turn the glass substrate at the cutting line into a molten state. At this time, the laser heat absorbed by the upper glass substrate at the cutting line is less, and shape has not been greatly changed yet. The heat of laser beam cannot reach the lower glass substrate yet, and so it will not cause damage to the circuit system on the lower glass substrate. After that, impulsive fluid is jetted toward the upper glass substrate at the cutting line that has become a molten state with the use of the impulsive fluid jet unit 101, so as to cut apart the cutting line in a molten state by utilizing an impulsive force of the impulsive fluid, and molten scraps at the cutting line will flow away along with an impact of the impulsive fluid. As such, the upper glass substrate will be cut open along the cutting line.

Regarding the water jet laser cutting device provided by embodiments of the invention, by means of emitting laser beam to a cutting line of a workpiece from a laser beam emitting unit, the workpiece at the cutting line is turned into a molten state, and as compared to the case in prior art where a workpiece at the location of a cutting line needs to be liquefied or gasified, the intensity of the laser beam necessary for turning the workpiece at the cutting line into a molten state is lower, and the heat of laser beam is less. Therefore, the molten thickness is easy to control when laser beam melts the workpiece at the cutting line, so as not to cause overcut. When the workpiece at the cutting line turns into a molten state, impulsive fluid is jetted toward the cutting line with the use of the impulsive liquid jet unit, so as to cut apart the cutting line in a molten state by utilizing an impulsive force of the impulsive fluid, and remove molten scraps at the cutting line. Thus, a flexible cutting is realized. As such, by means of precisely controlling thermally penetrated thickness of laser beam, damage to a non-cutting region of a workpiece caused by heat of laser beam upon workpiece cutting in prior art is avoided, and the control precision of cutting is enhanced. In addition, when a precise workpiece placed in water is subjected to laser cutting in prior art, plasmas generated after water interacts with laser beam may be attached to the precise workpiece, causing harm to a surface of the precise workpiece. However, what is adopted in embodiments of the invention is flowing impulsive fluid, the contact time between the flowing impulsive fluid and laser beam is short, generated plasmas are few, and the generated plasmas will flow away together with the flowing impulsive fluid, and will not be attached to a surface of the precise workpiece. As such, harm done to the precise workpiece upon cutting is decreased.

Further, the impulsive fluid jet unit 101 can implement the following operations: a cutting line is impacted with a first impulsive fluid to partially cut the cutting line in a molten state, so that a precutting line is formed at the cutting line, in this case, the portions of the workpiece at both sides of the cutting line are still connected to each other; the precutting line is impacted with a second impulsive fluid, so that the precutting line is cut apart completely; content of water in the first impulsive fluid is greater than content of water in the second impulsive fluid.

In some examples, the first impulsive fluid is a mixture of 90-99 vol % water and 10-1 vol % steam. In actual applications, 90-99 vol % water and 10-1 vol % steam may be evenly mixed by using a gas-liquid mixing pump to produce a first impulsive fluid. The first impulsive fluid mainly made of water is then jetted onto a cutting line of a workpiece with an appropriate jetting intensity, and the cutting line in a molten state will be cut apart by an impulsive force of the impulsive fluid, so as to form a precutting line. The precutting line is a cutting line where most of molten scraps are removed and a small amount of molten scraps are residual, wherein, a small amount of molten scraps being left over is for the purpose of protecting a non-cutting region of the workpiece, so as to avoid it from being damaged under the impact of the first impulsive fluid. Furthermore, upon production of the first impulsive fluid, a small amount of steam is mixed into the water, helping to generation of a water film when the first impulsive fluid is jetted onto the cutting line of the workpiece. Temperature at the cutting line can be favorably cooled by the water film, so as to avoid the workpiece from being deformed and harmed by heat that is generated by laser beam irradiation.

In some examples, the second impulsive fluid is a mixture of 1-10 vol % water and 99-90 vol % steam. Owing to a higher temperature of steam, after a cutting line is impacted with a first impulsive fluid so as to partially cut the cutting line in a molten state by using an impulsive force of the impulsive fluid, and remove most of molten scraps at the cutting line, only a very small amount of molten scraps are left over at the cutting line, thereby forming a very thin connection layer. At this time, the second impulsive fluid mainly made of high-temperature steam is then jetted onto the very thin connection layer at the cutting line, and partially leftover molten scraps at the cutting line are fully removed by using the principle of heat expansion and cold contraction, so as to disconnect the very thin connection layer. Thus, an object of cutting workpiece is achieved. Because the cut thickness can be precisely controlled by this flexible cutting, damage to a non-cutting region of the workpiece caused by heat of laser beam upon laser cutting is avoided.

Exemplarily, when an upper glass substrate of a liquid crystal display panel is cut, the glass substrate at a cutting line is turned into a molten state by means of transmitting laser beam toward the cutting line of the upper glass substrate from a laser beam emitting unit. Next, a first impulsive fluid is jetted toward the glass substrate in a molten state at the cutting line with the use of an impulsive liquid jet unit, and by means of controlling the jetting intensity of the first impulsive fluid, most of molten scraps are removed while the cutting line in a molten state is partially cut by using an impulsive force of the impulsive fluid, so as to render the cutting line of the glass substrate disconnected incompletely. In this course, the laser beam emitting unit and the impulsive fluid jet unit work simultaneously, and move in the same direction. After the laser beam and the first impulsive fluid act on the cutting line of the upper glass substrate for one time, the upper glass substrate at the cutting line has not been disconnected completely, and one connection layer that is very thin still exists. After that, a second impulsive fluid is jetted toward the connection layer by using an impulsive fluid jet unit, so as to disconnect the connection layer by utilizing the temperature characteristic of the second impulsive fluid. Thus, an object of cutting the upper glass substrate is achieved. The cut thickness is well controlled by this method, so as not do harm to the lower glass substrate.

Further, as illustrated in FIG. 2, the water jet laser cutting device 10 further includes a control unit 103, useful for controlling intensity of jetting an impulsive fluid of the impulsive fluid jet unit 101 and intensity of laser beam emitted by the laser beam emitting unit 102.

The control unit 103 may be a control circuit, or may also be a programmable logic controller, and embodiments of the invention do not set a limit to this. For example, the control unit 103 is a programmable logic controller, in which the mixing ratio of impulsive fluids, intensity of jetting impulsive fluids, intensity of emitted laser beam, and other parameters are stored, which acts to control normal operation of the water jet laser cutting device 10.

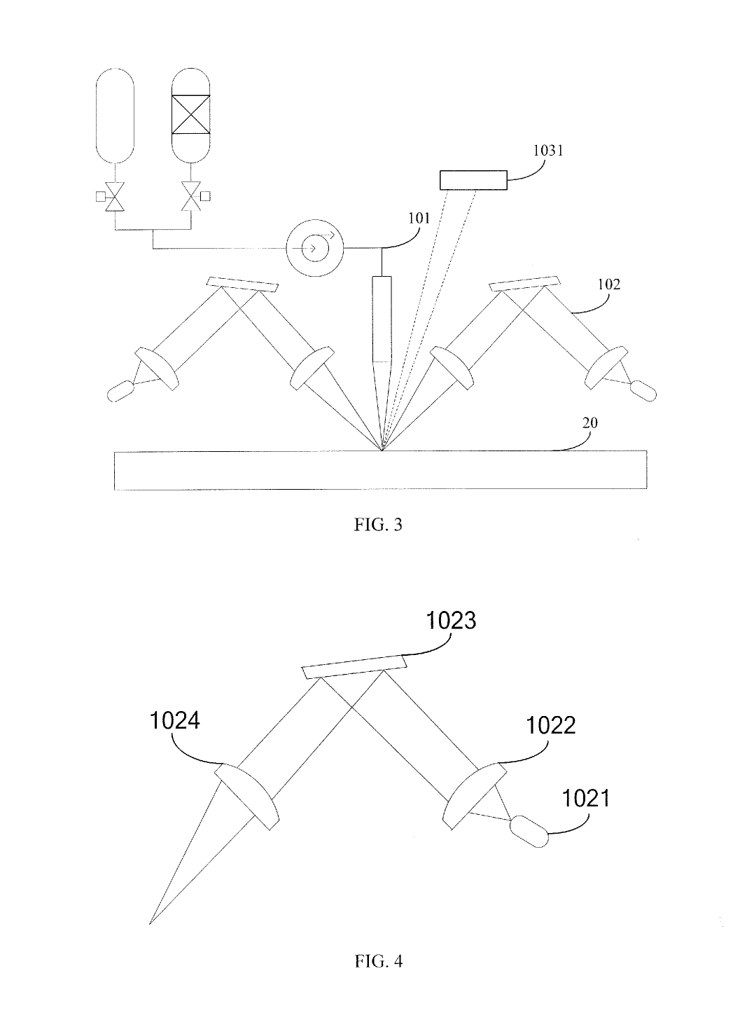

In some examples, the control unit 103 includes an infrared monitor 1031, for detecting temperature at an operating point, which is an arbitrary point on the cutting line of the workpiece. The control unit 103 is useful, for example, for controlling the intensity of an impulsive fluid that is jetted onto the operating point by the impulsive fluid jet unit 101 and the intensity of laser beam that is emitted to the operating point by the laser beam emitting unit 102 according to temperature at the operating point. As illustrated in FIG. 3, the infrared monitor 1031 detects the temperature at the operating point.

The infrared monitoring can be classified into two forms: an active mode and a passive mode. The active mode is that, an infrared monitor initiatively emits infrared light beams toward the working point on the cutting line, and then judges the temperature at the operating point on the cutting line in accordance with the received feedback information; and the passive mode is that, an infrared monitor does not emit infrared light beams in itself, and judges the temperature at the operating point on the cutting line in accordance with the detected infrared information of surrounding environment. Here, the infrared monitor for detecting temperature at the operating point may be of an active mode, and may also be of a passive mode, embodiments of the invention do not set a limit to this. Exemplarily, when it has been detected by the infrared monitor that temperature at the operating point on the cutting line at this time is higher, temperature at the operating point can be controlled by increasing intensity of an impulsive fluid jetted onto the operating point by the impulsive fluid jet unit 101 and/or decreasing intensity of laser beam emitted to the operating point by the laser beam emitting unit 102, so as to avoid damage to workpiece in a non-cutting region caused by an overhigh temperature at the operating point.

For example, as illustrated in FIG. 3, the water jet laser cutting device 10 includes at least two laser beam emitting units 102; laser beam emitted by the at least two laser beam emitting units 102 and an impulsive fluid jetted by the impulsive fluid jet unit 101 lie in a first plane, and the cutting line of the workpiece 20 is perpendicular to the first plane. Such an arrangement manner that two laser beam emitting units 102 make an angle with each other may make laser beam emitted by the laser beam emitting unit 102 be irradiated fully on the cutting line of the workpiece 20, and when the cutting line is wider and the laser beam zone irradiated onto the workpiece 20 is smaller, a larger laser beam irradiating area can be realized by setting of two laser beam emitting units 102. As such, cutting requirements can be achieved only by scanning the workpiece 20 for one time with the water jet laser cutting device 10. Referring to that illustrated in FIG. 3, the impulsive fluid jet unit 101 is arranged in the middle of two laser beam emitting units 102, and an impulsive fluid jetted by the impulsive fluid jet unit 101 and laser beam emitted by the two laser beam emitting units 102 lie in the same plane. As such, when laser beam emitted by the laser beam emitting unit 102 melts a cutting line on the workpiece 20, with the aid of an impulsive fluid jetted by the impulsive fluid jet unit 101, the cutting line in a molten state can be immediately cut apart, and molten scraps at the cutting line are removed.

Optionally, laser beam emitted by at least one laser beam emitting unit 102, an impulsive fluid jetted by the impulsive fluid jet unit 101 and the cutting line of the workpiece 20 lie in the same plane. As such, laser beam emitted by the laser beam emitting unit 102 can irradiates onto the cutting line of the workpiece 20 fully, and an impulsive fluid jetted by the impulsive fluid jet unit 101 can cooperate with the laser beam emitting unit 102 better in cutting apart the cutting line and removing molten scraps at the cutting line. Moreover, a kerf at the cutting line is relatively smooth, and microcracks are not easy to occur.

As illustrated in FIG. 4, the laser beam emitting unit 102 may include a laser 1021, a planoconvex collimating lens 1022, a planar mirror 1023 and a planoconvex focusing lens 1024. After laser beams emitted by the laser 1021 pass through the planoconvex collimating lens 1022, light paths of the laser beams turn to be parallel light paths, and after that, they are reflected by the planar mirror 1023 to the planoconvex focusing lens 1024. Laser beams in parallel light paths are focused by the planoconvex focusing lens 1024, so as to form laser beams with high energy and high intensity, and then, the laser beams can be used for cutting of the workpiece.

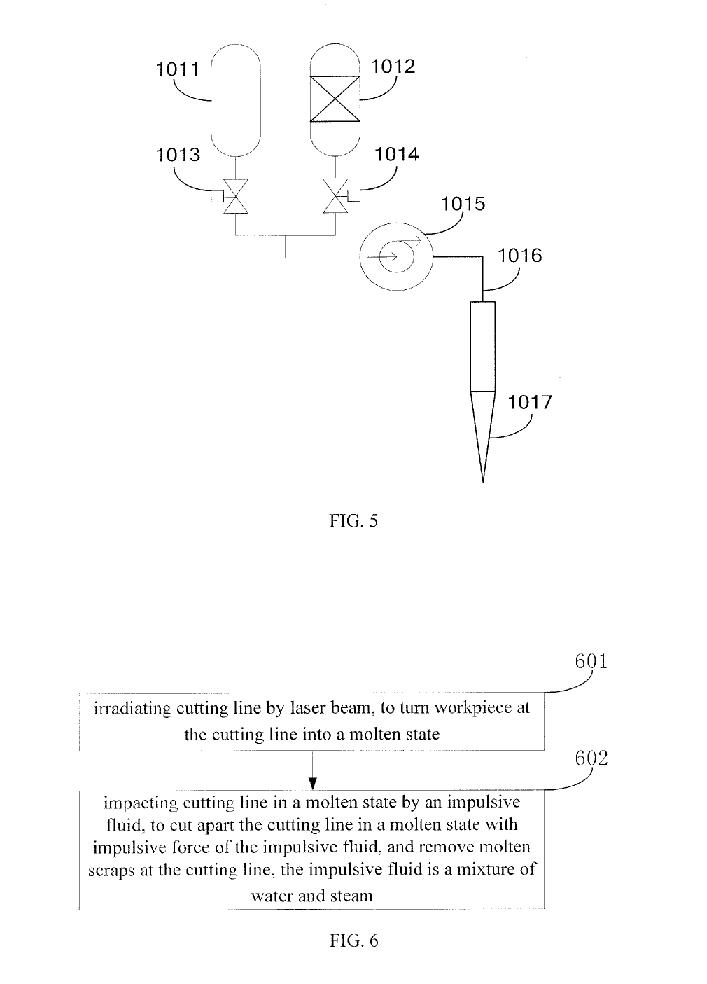

Further, as illustrated in FIG. 5, the impulsive fluid jet unit 101 includes a liquid tank 1011 and a steam generator 1012. The liquid tank 1011 is connected to a liquid control valve 1013 for controlling liquid flux, the steam generator 1012 is connected to a gas control valve 1014 for controlling gas flux, and the liquid control valve 1013 and the gas control valve 1014 are each connected to a gas-liquid mixing pump 1015. The impulsive fluid jet unit 101 further includes a jet pipe 1016 and a nozzle 1017. The jet pipe 1016 is connected to the gas-liquid mixing pump 1015 and useful for transporting an impulsive fluid to the nozzle, and the nozzle 1017 is connected to the jet pipe 1016 and useful for jetting an impulsive fluid in the jet pipe 1016 onto a cutting line. The control unit 103 acts to take control of intensity of an impulsive fluid by control of the gas-liquid mixing pump 1015.

Nozzles of a variety of substances may be selected for the nozzle 1017, and embodiments of the invention do not set a limit to this. In some examples, upon jetting of the first impulsive fluid, because a cutting line in a molten state has to be partially cut by using an impulsive force of the first impulsive fluid, a ruby nozzle that is fine and has a high hardness may be selected. The reason is that, it can be guaranteed by it that the jetted impulsive fluid has a small diameter and a high pressure, and this is helpful for cutting. Upon jetting of the second impulsive fluid, because a precutting line is cut by utilizing high-temperature characteristics of the second impulsive fluid and the principle of heat expansion and cold contraction and it is necessary for the second impulsive fluid to spread all over the precutting line evenly, a shower nozzle can be selected. In an actual operation, switchover can be performed by means of controlling the nozzle 1017 with the control unit 103. Referring to that illustrated in FIG. 5, it is possible that the mixing ratio of water and steam is controlled by taking control of the liquid control valve 1013 and the gas control valve 1014, so as to make up the first impulsive fluid or the second impulsive fluid; next, the jetting intensity of the first impulsive fluid or the second impulsive fluid is controlled by controlling rotating speed of the gas-liquid mixing pump 1015; and then, the first impulsive fluid or the second impulsive fluid is jetted toward the cutting line of the workpiece through the nozzle 1017.

With respect to the water jet laser cutting device provided by embodiments of the invention, the device includes an impulsive fluid jet unit and at least one laser beam emitting unit. Each laser beam emitting unit is useful for emitting light to a cutting line, so as to turn a workpiece at the cutting line into a molten state; and the impulsive fluid jet unit is useful for jetting an impulsive fluid toward the cutting line in a molten state, so that the cutting line in a molten state is cut apart by using an impulsive force of the impulsive fluid, and molten scraps at the cutting line are removed, wherein, the impulsive fluid is mixture of water and steam. In the water jet laser cutting device provided by embodiments of the invention, a workpiece at a cutting line is turned into a molten state by means of emitting laser beam toward the cutting line of the workpiece with the laser beam emitting unit, and as compared to the case in prior art that a workpiece at a cutting line needs to be liquefied or gasified, the intensity of laser beam required when the workpiece at the cutting line is turned into a molten state is lower, the heat of laser beam is smaller. Therefore, molten thickness is easy to control when laser beam melts the workpiece at the cutting line, so as not to cause overcut. When the workpiece at the cutting line turns into a molten state, impulsive fluid is jetted toward the cutting line with the use of the impulsive liquid jet unit, so as to cut apart the cutting line in a molten state by utilizing an impulsive force of the impulsive fluid, and remove molten scraps at the cutting line. Thus, a flexible cutting is realized. As such, by means of precisely controlling thermally penetrated thickness of laser beam, damage to a non-cutting region of a workpiece caused by heat of laser beam upon workpiece cutting in prior art is avoided, and the control precision of cutting is enhanced. In addition, when a precise workpiece placed in water is subjected to laser cutting in prior art, plasmas generated after water interacts with laser beam may be attached to the precise workpiece, causing harm to a surface of the precise workpiece. However, what is adopted in embodiments of the invention is flowing impulsive fluid, the contact time between the flowing impulsive fluid and laser beam is short, generated plasmas are few, and the generated plasmas will flow away together with the flowing, impulsive fluid, and will not be attached to a surface of the precise workpiece. As such, harm done to the precise workpiece upon cutting is decreased.

According to another embodiment of the invention, there is provided a water jet laser cutting method. As illustrated in FIG. 6, the method steps include:

Step 601, a cutting line is irradiated by laser beam, so as to turn a workpiece at the cutting line into a molten state.

Step 602, the cutting line in a molten state is impacted by an impulsive fluid, so as to cut apart the cutting line in a molten state by using an impulsive force of the impulsive fluid, and remove molten scraps at the cutting line, the impulsive fluid is a mixture of water and steam.

Regarding the water jet laser cutting method provided by embodiments of the invention, a workpiece at a cutting line is turned into a molten state by means of irradiating the cutting line with laser beam, and as compared to the case in prior art that a workpiece at a cutting line needs to be liquefied or gasified, the intensity of laser beam required when the workpiece at the cutting line is turned into a molten state is lower, the heat of laser beam is smaller. Therefore, molten thickness is easy to control when laser beam melts the workpiece at the cutting line, so as not to cause overcut. When the workpiece at the cutting line turns into a molten state, the cutting line in a molten state is impacted with an impulsive fluid, so as to cut apart the cutting line in a molten state by utilizing an impulsive force of the impulsive fluid, and remove molten scraps at the cutting line. Thus, a flexible cutting is realized. As such, by means of precisely controlling thermally penetrated thickness of laser beam, damage to a non-cutting region of a workpiece caused by heat of laser beam upon workpiece cutting in prior art is avoided, and the control precision of cutting is enhanced. In addition, when a precise workpiece placed in water is subjected to laser cutting in prior art, plasmas generated after water interacts with laser beam may be attached to the precise workpiece, causing harm to a surface of the precise workpiece. However, what is adopted in embodiments of the invention is flowing impulsive fluid, the contact time between the flowing, impulsive fluid and laser beam is short generated plasmas are few, and the generated plasmas will flow away together with the flowing, impulsive fluid, and will not be attached to a surface of the precise workpiece. As such, harm done to the precise workpiece upon cutting is decreased.

Further, impacting the cutting line by an impulsive fluid so as to cut apart the cutting line in a molten state by using an impulsive force of the impulsive fluid and remove molten scraps at the cutting line includes the following steps. Firstly, a cutting line is impacted by a first impulsive fluid to partially cut the cutting line in a molten state, so that a precutting line is formed at the cutting line; next, the precutting line is impacted by a second impulsive fluid, so that the precutting line is cut apart completely; content of water in the first impulsive fluid is larger than content of water in the second impulsive fluid. In the course of forming the precutting line, most of molten scraps are removed by the first impulsive fluid. Embodiments of the invention do not set a special limit to the percentage of removed molten scraps to the total molten scraps, as long as a non-cutting region of the workpiece can be protected by residual molten scraps.

In some examples, the first impulsive fluid is a mixture of 90-99 vol % water and 10-1 vol % steam; and the second impulsive fluid is a mixture of 1-10 vol % water and 99-90 vol % steam.

In addition, the water jet laser cutting method according to embodiments of the invention may further include any operation steps that have been described above in combination with the water jet laser cutting device, and they will not be described one by one any longer here. For example, the method may further include detecting the temperature at a working point, which is any point on the cutting line of the workpiece; and controlling the intensity of an impulsive fluid jetted onto the working point and the intensity of laser beam irradiated onto the working point according to the temperature at the working point. For example, in some examples, irradiating the cutting line by laser beam includes irradiating the cutting line by at least two laser beams.

With respect to the water jet laser cutting method provided by embodiments of the invention, it includes that, firstly, a cutting line is irradiated by laser beam to turn the cutting line into a molten state; next, the cutting line is impacted by an impulsive fluid, so as to cut apart the cutting line in a molten state with an impulsive force of the impulsive fluid, and remove molten scraps at the cutting line, the impulsive fluid being a mixture of water and steam. In the water jet laser cutting method provided by embodiments of the invention, a workpiece at a cutting line is turned into a molten state by means of irradiating the cutting line with laser beam, and as compared to the case in prior art that a workpiece at a cutting line needs to be liquefied or gasified, the intensity of laser beam required when the workpiece at the cutting line is turned into a molten state is lower, the heat of laser beam is smaller. Therefore, molten thickness is easy to control when laser beam melts the workpiece at the cutting line, so as not to cause overcut. When the workpiece at the cutting line turns into a molten state, the cutting line in a molten state is impacted with an impulsive fluid, so as to cut apart the cutting line in a molten state by utilizing an impulsive force of the impulsive fluid, and remove molten scraps at the cutting line. Thus, a flexible cutting is realized. As such, by means of precisely controlling thermally penetrated thickness of laser beam, damage to a non-cutting region of a workpiece caused by heat of laser beam upon workpiece cutting in prior art is avoided, and the control precision of cutting is enhanced. In addition, when a precise workpiece placed in water is subjected to laser cutting in prior art, plasmas generated after water interacts with laser beam may be attached to the precise workpiece, causing harm to a surface of the precise workpiece. However, what is adopted in embodiments of the invention is flowing impulsive fluid, the contact time between the flowing impulsive fluid and laser beam is short, generated plasmas are few, and the generated plasmas will flow away together with the flowing, impulsive fluid, and will not be attached to a surface of the precise workpiece. As such, harm done to the precise workpiece upon cutting is decreased.

It can be clearly understood by those skilled in the art that, for the sake of convenience and concise of illustration, reference to corresponding procedures in the foregoing water jet laser cutting device embodiments may be made by concrete steps of the above-described method, and details are omitted here.

It is to be noted that, the sequential order of steps of the water jet laser cutting method provided by embodiments of the invention may be appropriately adjusted, and steps may also be added or decreased accordingly depending on the circumstances. Any modified method, as would be obvious to those skilled in the art within the technical scope disclosed by the present invention, shall be embraced within the protection scope of the invention, and therefore, details are omitted.

In several embodiments provided by the present application, it should be understood that, the disclosed device and method may be implemented in other manner. For example, device embodiments as described above are merely for illustration. For example, division of the units is merely a logic function division, and other dividing mode is possible upon actual implementation. For example, multiple units or components may be combined or may be integrated into another system, or some characteristics may be ignored, or not be implemented. One more point is that, mutual coupling or direct coupling as displayed or discussed may be an indirect coupling through some interfaces, devices or units, and it may be electrical, mechanical or in other form.

The units described as discrete components may be or may also not be physically separated, and components displayed as units may be or may also not be physical units. That is, they may be in a place, or may also be distributed over a plurality of units. The purpose of solution of the embodiment can be achieved by selecting part of all of the units according to actual requirements.

In addition, various functional units in each embodiment of the invention may be integrated into a processing unit, it may also be possible that each unit is individually, physically included, and it may also be possible that two or more units are integrated into one unit. The integrated units above may be implemented in the form of hardware, and may also be implemented in the form of hardware plus software functional unit.

The foregoing embodiments merely are exemplary embodiments of the invention, and not intended to define the scope of the invention, and the scope of the invention is determined by the appended claims.

The application claims priority of Chinese Patent Application No. 201410664721.2 filed on Nov. 19, 2014, the disclosure of which is incorporated herein by reference in its entirety as part of the present application.

1. A water jet laser cutting device, comprising an impulsive fluid jet unit and at least one laser beam emitting unit, wherein,
each laser beam emitting unit is configured to emit a laser beam toward a cutting line, so as to turn a workpiece at the cutting line into a molten state; and
the impulsive fluid jet unit is configured to jet an impulsive fluid toward the cutting line in the molten state, so as to cut apart the cutting line in the molten state with an impulsive force of the impulsive fluid, and remove molten scraps at the cutting line.

2. The device according to claim 1, wherein, the impulsive fluid is a mixture of water and steam.

3. The device according to claim 2, wherein,
the impulsive fluid jet unit is configured to,
impact the cutting line by a first impulsive fluid to partially cut the cutting line in the molten state, so that a precutting line is formed at the cutting line; and
impact the precutting line by a second impulsive fluid, so that the precutting line is cut apart completely,
content of water in the first impulsive fluid is greater than content of water in the second impulsive fluid.

4. The device according to claim 3, wherein,
the first impulsive fluid includes 90-99 vol % water;
the second impulsive fluid includes 1-10 vol % water.

5. The device according to claim 1, further comprising a control unit, which is configured to control an intensity of the impulsive fluid jetted by the impulsive fluid jet unit and an intensity of the laser beam emitted by the laser beam emitting unit.

6. The device according to claim 5, wherein, the control unit includes an infrared monitor useful for detecting a temperature at an operating point, which is any point on the cutting line of the workpiece; and
the control unit is configured to control the intensity of the impulsive fluid jetted on the operating point by the impulsive fluid jet unit and the intensity of the laser beam emitted on the operating point by the laser beam emitting unit based on the temperature at the operating point.

7. The device according to claim 1, wherein, the laser beam emitted by the at least one laser beam emitting unit, the impulsive fluid jetted by the impulsive fluid jet unit and the cutting line of the workpiece lie in a same plane.

8. The device according to claim 1, wherein, the device includes at least two laser beam emitting units;
the laser beam emitted by the at least two laser beam emitting units and the impulsive fluid jetted by the impulsive fluid jet unit lie in a first plane, and the cutting line of the workpiece is perpendicular to the first plane.

9. The device according to claim 5, wherein, the impulsive fluid jet unit includes a liquid tank, a steam generator, a gas-liquid mixing pump, a jet pipe and a nozzle,
wherein, the liquid tank is connected to a liquid control valve for controlling liquid flux, the steam generator is connected to a gas control valve for controlling gas flux, and the liquid control valve and the gas control valve are each connected to a gas-liquid mixing pump;
the jet pipe is connected to the gas-liquid mixing pump, and configured to transport the impulsive fluid to the nozzle;
the nozzle is connected to the jet pipe, and configured to jet the impulsive fluid in the jet pipe onto the cutting line; and
the control unit is configured to control the intensity of the impulsive fluid by control of the gas-liquid mixing pump.

10. A water jet laser cutting method, comprising:
irradiating a cutting line by a laser beam, so as to turn a workpiece at the cutting line into a molten state; and
impacting the cutting line in the molten state by an impulsive fluid, so as to cut apart the cutting line in the molten state with an impulsive force of the impulsive fluid, and remove molten scraps at the cutting line.

11. The method according to claim 10, wherein, the impulsive fluid is a mixture of water and steam.

12. The method according to claim 11, wherein, impacting the cutting line in the molten state by the impulsive fluid so as to cut apart the cutting line in the molten state with the impulsive force of the impulsive fluid and remove the molten scraps at the cutting line includes:
impacting the cutting line by a first impulsive fluid to partially cut the cutting line in the molten state, so that a precutting line is formed at the cutting line;
impacting the precutting line by a second impulsive fluid, so that the precutting line is cut apart completely,
content of water in the first impulsive fluid is greater than content of water in the second impulsive fluid.

13. The method according to claim 12, wherein,
the first impulsive fluid includes 90-99 vol % water;
the second impulsive fluid includes 1-10 vol % water.

14. The method according to claim 10, further comprising:
detecting a temperature at an operating point, which is any point on the cutting line of the workpiece; and
controlling an intensity of the impulsive fluid jetted onto the operating point and an intensity of the laser beam irradiated onto the working point in accordance with the temperature at the operating point.

15. The method according to claim 10, wherein, irradiating the cutting line by the laser beam includes irradiating the cutting line by at least two laser beams.
